(19) United States
(12) Patent Application Publication
(10) Pub. No.: US 2007/0085054 A1
(43) Pub. Date: Apr. 19, 2007

(54) Working fluid for heat pipe

(75) Inventor: Mong-Tung Lin, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/481,728

(22) Filed: Jul. 5, 2006

(30) Foreign Application Priority Data
Oct. 13, 2005 (CN) 200510100381.1

(51) Int. Cl. C09K 3/18

(52) U.S. Cl. 252/70

(57) ABSTRACT

A working fluid for heat pipe includes a liquid and a plurality of nano-sized particles dispersed in the liquid. The liquid has a surface tension increasing with increasing temperature in a working temperature range of the heat pipe. The working fluid for heat pipe has a surface tension increasing with increasing temperature in a working temperature range of the heat pipe can avoid capillary limit of the heat pipe reducing at operating temperature range of the heat pipe. The nano-sized particles dispersed in the working fluid have high thermal conductivities, and the performance of the heat pipe can be enhanced.

### TECHNICAL FIELD

The present invention relates generally to the field of heat transfer, and more particularly to a working fluid and a heat pipe having the working fluid.

### BACKGROUND

Heat pipes can be described as closed devices employing evaporating-condensing cycles for transporting heat from a locale of heat generation to a location of heat dissipation, and using capillary structures or wicks for return of the condensate. These devices often have the shape of a pipe or tube that is closed on both ends. However, the term “heat pipe” can also be used in a more general sense to refer to devices of any type of geometry that are designed to function as described.

The heat pipe is a highly efficient heat transfer system and has been broadly used in spacecraft, energy recuperation, power generation, chemical engineering, electronics cooling, air conditioning, engine cooling and other applications. Recently, thermal management has become one of the most critical technologies in electronic product development and directly influences reliability, and performance of the finished products. Heat pipes are excellent heat transfer devices, but a serious constraint on conventional heat pipes is the reduction of transport capabilities in which the condenser is located below the evaporator section in a gravitational field, or when the heat pipes are used under low-gravity conditions.

All of the heat pipes, including conventional heat pipes, capillary pumped loops (CPLs), loop heat pipes (LHPs), and micro heat pipes, have a common concern, namely the heat transfer limits. These limits determine the maximum heat transfer rate that a particular heat pipe can achieve under certain working conditions. Among them the capillary limit is the restrictive factor at normal operating temperatures. One of the factors causing the capillary limit is the surface tension of working fluid in the heat pipe. Conventional working fluid has a negative surface-tension gradient with temperature, and reduces the capillary limit when the operating temperature at the evaporator section is increased.

Besides that, in order to ensure the effective operation of the heat pipe, the working fluid must have high thermal conductivity

What is needed, therefore, is a working fluid for heat pipes with high thermal conductivity and having a surface tension increasing with increasing temperature in a working temperature range of the heat pipe.

### SUMMARY

In accordance with an embodiment, a working fluid for heat pipe includes a liquid and a plurality of nano-sized particles dispersed in the liquid. The liquid has a surface tension increasing with increasing temperature in a working temperature range of the heat pipe.

Other advantages and novel features will become more apparent from the following detailed description of present working fluid for heat pipe, when taken in conjunction with the accompanying drawings.

### BRIEF DESCRIPTION OF THE DRAWINGS

Many aspects of the present working fluid and related heat pipe can be better understood with reference to the following drawings. The components in the drawings are not necessarily to scale, the emphasis instead being placed upon clearly illustrating the principles of the present working fluid for heat pipe. Moreover, in the drawings, like reference numerals designate corresponding parts throughout the several views.

FIG. 1 is a schematic, cross-sectional view of a heat pipe according to a first embodiment;

FIG. 2 is a flow chart of a method for making a working fluid for heat pipes according to a second embodiment.

### DETAILED DESCRIPTION OF THE EMBODIMENTS

Embodiments of the present working fluid for heat pipe will now be described in detail below and with reference to the drawings.

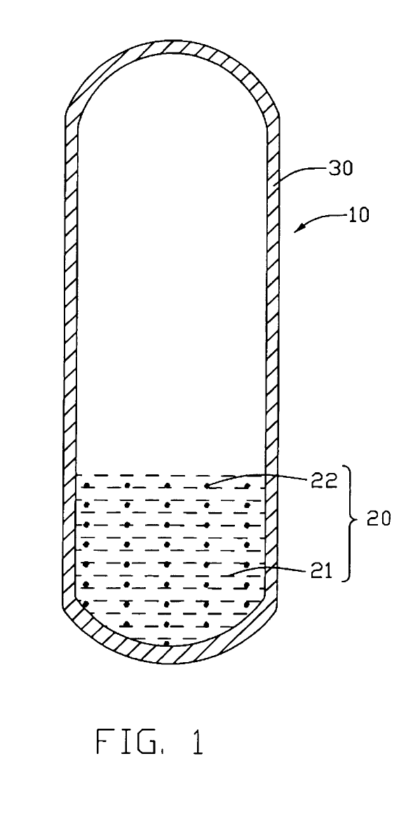

Referring to FIG. 1, a heat pipe 10 according to a first embodiment includes a container 30 and a working fluid 20 received in the container 30. The working fluid 20 includes a liquid 21 and a plurality of nano-sized particles 22 dispersed in the liquid 21. The liquid 21 has a surface tension increasing with increasing temperature in a working temperature range of the heat pipe 10.

The liquid 21 includes at least one type of long-chain alcohol. The long-chain alcohol can be selected from the group consisting of C₄ to C₁₀ alcohols and mixtures thereof. The long-chain alcohol can be selected from straight alcohol and branched chain alcohol. Preferably, the liquid 21 is a solution with long-chain alcohol as a solute. The solvent of the solution can be selected from the group consisting of water, alcohol, ketone, and any mixture thereof The alcohol can be selected from the group consisting of methanol, ethanol, propanol, n-butanol, n-pentanol, n-hexanol, n-heptanol, n-octanol, glycol, and any suitable mixture thereof. The ketone can be acetone. In order to have a surface tension increasing with increasing temperature in a working temperature range of the heat pipe 10, the content of the long-chain alcohol in the solution should greater than 0.0005 moles per liter.

The liquid 21 further comprises a polymer protective agent configured for preventing aggregation of the nano-sized particles 22. The protective agent is dispersed in the liquid 21. The polymer protective agent includes a material selected from the group consisting of polyvinyl alcohol, polyvinyl pyrrolidone, and combination thereof.

The nano-sized particles 22 can be made from a material selected from the group consisting of ceramics, metals, carbon, and any combinations thereof. The ceramic includes a material selected from the group consisting of Al₂O₃, CuO, SiN, AlN, ZnO, and any combinations thereof The metal includes a material selected from the group consisting of Al, Cu, Au, Ag, and any alloys thereof The carbon includes a material selected from the group consisting of graphite, diamond, carbon nanotube, carbon nanocapsule, and any combinations thereof The grain size of each nano-sized particle 22 is in the range from 1 to 100 nanometers. The nano-sized particles 22 are in an amount by mass of 0.1 percent to 3 percent of the working fluid. A content by weight of the protective agent in the working fluid 20 is about 0.05 to 2 times greater than that of the nano-sized particles.

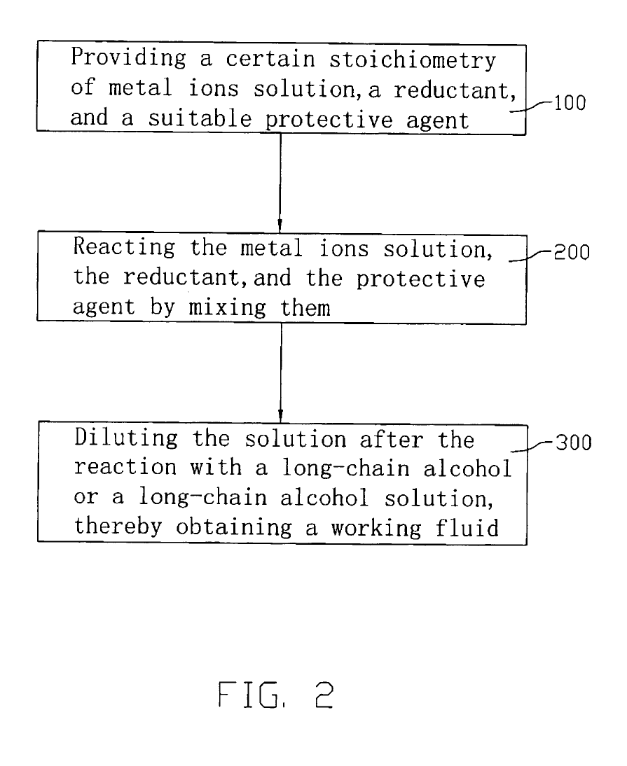

The working fluid 20 can be manufactured by a chemical reduction method according to a second embodiment. Referring to FIG. 2, the method comprises the steps of: step 100, providing a certain stoichiometry of metal ions solution, a reductant, and a suitable protective agent; step 200, reacting the metal ions solution, the reductant, and the protective agent by mixing them; step 300, diluting the solution after the reaction with a long-chain alcohol or a long-chain alcohol solution, thereby obtaining a working fluid. The metal ions solution can be selected from the group consisting of hydrogen tetrachloroaurate hydrate, silver nitrate, silver perchlorate, copper sulfate, silver chloride, cupric nitrate, and any suitable mixture thereof The reductant can be selected from the group consisting of sodium borohydride, sodium hypophosphite, hydrazine, stannous chloride, sodium citrate, tannin, polyvinyl alcohol, polyvinyl pyrrolidone, quaternary ammonium salt, and any suitable mixture thereof The solvent of the long-chain alcohol solution can be selected from the group consisting of water, alcohol, ketone, and any mixture thereof The alcohol can be selected from the group consisting of methanol, ethanol, propanol, n-butanol, n-pentanol, n-hexanol, n-heptanol, n-octanol, glycol, and any suitable mixture thereof The ketone can be acetone.

As stated above, the present working fluid for heat pipe has a surface tension increasing with increasing temperature in a working temperature range of the heat pipe and can therefore avoid a capillary limit of the heat pipe reducing in operating temperature range of the heat pipe. The nano-sized particles dispersed in the working fluid have high thermal conductivities, and the performance of the heat pipe can be enhanced. Furthermore, the protective agent dispersed in the working fluid can avoid the nano-sized particles congregating. Therefore, the working fluid in the heat pipe can circulate without blocking the capillaries.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A working fluid for a heat pipe, comprising:
a liquid having a surface tension increasing with increasing temperature in a working temperature range of the heat pipe; and
a plurality of nano-sized particles dispersed in the liquid.

2. The working fluid for heat pipe as claimed in claim 1, wherein the liquid further comprises a polymer protective agent configured for preventing aggregation of the nano-sized particles.

3. The working fluid for heat pipe as claimed in claim 2, wherein the polymer protective agent is comprised of a material selected from the group consisting of polyvinyl alcohol, polyvinyl pyrrolidone, and any combination thereof.

4. The working fluid for heat pipe as claimed in claim 2, wherein a content by weight of the polymer protective agent in the working fluid is about 0.05 to 2 times greater than that of the nano-sized particles.

5. The working fluid for heat pipe as claimed in claim 1, wherein the liquid comprises a long-chain alcohol selected from the group consisting of C₄ to C₁₀ alcohols and mixtures thereof.

6. The working fluid for heat pipe as claimed in claim 5, wherein the long-chain alcohol is selected from straight alcohol and branched chain alcohol.

7. The working fluid for heat pipe as claimed in claim 5, wherein the content of the long-chain alcohol in the liquid is greater than 0.0005 moles per liter.

8. The working fluid for heat pipe as claimed in claim 1, wherein the liquid further comprises a material selected from the group consisting of water, alcohol, ketone, and any combination thereof.

9. The working fluid for heat pipe as claimed in claim 1, wherein the alcohol is selected from the group consisting of methanol, ethanol, propanol, n-butanol, n-pentanol, n-hexanol, n-heptanol, n-octanol, glycol, and any suitable mixture thereof.

10. The working fluid for heat pipe as claimed in claim 1, wherein the ketone is acetone.

11. The working fluid for heat pipe as claimed in claim 1, wherein the nano-sized particles are comprised of a material selected from the group consisting of ceramics, metals, carbon, and any combinations thereof.

12. The working fluid for heat pipe as claimed in claim 11, wherein the ceramic is comprised of a material selected from the group consisting of Al₂O₃, CuO, BN, AlN, ZnO, and any combinations thereof.

13. The working fluid for heat pipe as claimed in claim 11, wherein the metal is comprised of a material selected from the group consisting of Al, Cu, Au, Ag, and any alloys thereof.

14. The working fluid for heat pipe as claimed in claim 11, wherein the carbon is comprised of a material selected from the group consisting of graphite, diamond, carbon nanotube, carbon nanocapsule, and any combinations thereof.

15. The working fluid for heat pipe as claimed in claim 1, wherein a grain size of each nano-sized particle is in the range from 1 to 100 nanometers.

16. The working fluid for heat pipe as claimed in claim 1, wherein the nano-sized particles are in an amount by mass of 0.1 percent to 3 percent of the working fluid.

17. A heat pipe, comprising:
a container;
a working fluid received in the container, the working fluid comprising a liquid having a surface tension increasing with increasing temperature in a working temperature range of the heat pipe and a plurality of nano-sized particles dispersed in the liquid.

18. The heat pipe as claimed in claim 17, wherein the liquid further comprises a polymer protective agent configured for preventing aggregation of the nano-sized particles.

19. The heat pipe as claimed in claim 17, wherein the liquid comprises a long-chain alcohol selected from the group consisting of C₄ to C₁₀ alcohols and mixtures thereof.

20. The heat pipe as claimed in claim 17, wherein the nano-sized particles are comprised of a material selected from the group consisting of ceramics, metals, carbon, and any combinations thereof.
